(19) United States
(12) Patent Application Publication
(10) Pub. No.: US 2024/0186533 A1
(43) Pub. Date: Jun. 6, 2024

(54) MEMBRANE-ELECTRODE ASSEMBLY, AND FUEL CELL INCLUDING SAME

(71) Applicant: POINT ENGINEERING CO., LTD., Chungcheongnam-do (KR)

(72) Inventors: Bum Mo AHN, Gyeonggi-do (KR); Young Heum EOM, Gyeonggi-do (KR); Sin Seok HAN, Gyeonggi-do (KR)

(73) Assignee: POINT ENGINEERING CO., LTD., Chungcheongnam-do (KR)

(21) Appl. No.: 18/285,852

(22) PCT Filed: Apr. 7, 2022
(86) PCT No.: PCT/KR2022/005048

§ 371 Date: Oct. 5, 2023

(30) Foreign Application Priority Data
Apr. 9, 2021 (KR) 10-2021-0046349

(51) Int. Cl. H01M 4/90; H01M 4/86; H01M 8/10; H01M 8/1004

(52) U.S. Cl. CPC H01M 4/9016; H01M 4/8605; H01M 4/8657; H01M 8/1004; H01M 2008/1095

(57) ABSTRACT

The present invention provides a membrane-electrode assembly for a fuel cell, and a fuel cell comprising same, wherein the cross-sectional area for reaction activation can be increased compared to the prior art, and the reaction area can be made uniform for each product compared to the prior art by making reaction gases (H2 and O2) undergo an ionization process while reacting with catalyst material, provided on the inner walls of regularly arranged pores, while moving through channels following the pores.

### TECHNICAL FIELD

The present disclosure relates to a membrane-electrode assembly, and a fuel cell including the same.

### BACKGROUND ART

A fuel cell is a power generating system that directly converts the chemical reaction energy of hydrogen, contained in hydrocarbon-based materials such as methanol, and oxygen into electrical energy.

Fuel cells use hydrogen made by reforming methanol or ethanol as fuel, and have the advantage of having a wide range of applications. That is, the fuel cells can be used as a mobile power source for vehicles, as a distributed power source for houses and public buildings, and as a small power source for electronic devices.

A fuel cell has a unit cell composed of a membrane-electrode assembly (MEA), which generates electricity through the oxidation/reduction (redox) reaction of hydrogen and oxygen, and separators (also called “bipolar plates”) that adhere closely to both sides of the MEA and supply hydrogen and oxygen to the MEA, and a plurality of these unit cells are stacked to form a fuel cell (or stack).

The membrane-electrode assembly includes an electrolyte membrane and a pair of electrodes (fuel electrode, air electrode), and the electrodes include a catalyst layer that promotes oxidation/reduction (redox) reactions and a gas diffusion layer provided on the outside of the catalyst layer and having breathability.

A conventional catalyst layer uses carbon fine powder called carbon black with a structure in which particles of 50 to 100 nm fuse into chain-like aggregates, and the surface of carbon black is provided with dispersed platinum (Pt) fine particles with a particle diameter of 1 to 5 nm.

A front channel through which hydrogen ions generated at the fuel electrode move is formed by the electrolyte, an electronic channel is formed by the carbon fine powder, and a gas channel is formed by the space between the carbon fine powders.

In the development of a membrane-electrode assembly (MEA), the point is how much the reaction on the platinum (Pt) catalyst surface can be promoted, and thus it is important to increase the reaction area that can contribute to the catalytic reaction.

However, in the conventional configuration, since platinum (Pt) fine particles are supported on the surface of carbon black, it is difficult to uniformly form platinum (Pt) particles on the surface of carbon black, and there is a limit to increasing the reaction area. Particularly, in the conventional case, if the ratio of platinum (Pt) fine particles is increased, the space between the carbon fine powders becomes narrow due to the agglomeration of the platinum (Pt) fine particles, causing problems such as reduced or uneven diffusion of gas, whereas when if the ratio of platinum (Pt) fine particles is lowered, the surface area of the platinum (Pt) fine particles decreases, causing a deterioration in performance of the fuel cell.

As such, in the conventional case, it is difficult to make the reaction area uniform and there are limitations in increasing the reaction area as reaction gases (H2, O2) undergo an ionization process while moving through channels formed by random pores.

### RELATED ART

### Patent Document

(Patent Document 1) Korean Patent Application Publication No. 2005-0121939

### DISCLOSURE

### Technical Problem

The present disclosure has been made keeping in mind the problems occurring in the related art. An objective of the present disclosure is to provide a membrane-electrode assembly for fuel cells, and a fuel cell including the same, wherein the cross-sectional area for reaction activation may be increased compared to the related art, and the reaction area may be made uniform for each product compared to the related art by making reaction gases (H2 and O2) undergo an ionization process while reacting with catalyst material, provided on the inner walls of regularly arranged through holes, while moving through channels formed by the through holes.

### Technical Solution

In order to achieve the above mentioned objectives, according to an embodiment of the present disclosure, there is provided a membrane-electrode for assembly fuel cells, including: an electrolyte membrane; and a pair of catalyst electrodes provided to face each other with the electrolyte membrane in between, wherein at least one of the catalyst electrodes may include an anodic oxide film including a plurality of spaced apart through holes, and a catalyst layer containing a catalyst material may be included on inner walls of the through holes.

In addition, the catalyst material may cover an entire exposed surface of the anodic oxide film, including the inner walls of the through holes and upper and lower surfaces of the anodic oxide film.

In addition, the catalyst material may be formed to a uniform thickness within a range of 1 nm to 100 nm.

In addition, each of the through holes may be a pore hole formed when manufacturing the anodic oxide film by anodizing a base metal.

In addition, each of the through holes may be a via hole formed to have a diameter larger than a diameter of a pore hole formed when manufacturing the anodic oxide film by anodizing a base metal.

In addition, the anodic oxide film may include: a porous layer having a pore hole; and a barrier layer formed on a side of the porous layer to seal the pore hole, wherein the barrier layer may be provided to face an opposite side of the electrolyte membrane.

In addition, the catalyst material may include a first layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, wherein the first layer may be formed with a uniform thickness along the inner walls of the through holes and upper and lower surfaces of the anodic oxide film.

In addition, the catalyst material may include a second layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but selected from a material different from the first layer and provided on the first layer, wherein the second layer may be formed with a uniform thickness along a surface of the first layer.

In addition, the catalyst material may include a first layer selected from a group consisting of platinum, ruthenium, osmium, platinum-ruthenium alloy, platinum-osmium alloy, platinum-palladium platinum-chromium alloy, platinum-nickel alloy, platinum-iron alloy, platinum-cobalt alloy, platinum-titanium alloy, and platinum-magnesium alloy; and a second layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but selected from a material different from the first layer and provided on the first layer, wherein the first layer may be provided in powder form, and the second layer may be formed to have a uniform thickness.

In addition, the catalyst material may include a first layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy; and a second layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but selected from a material different from the first layer and provided on the first layer, wherein the first layer may be formed to have a uniform thickness, and the second layer may be provided in powder form.

Meanwhile, a fuel cell according to the present disclosure includes: a membrane-electrode assembly including an electrolyte membrane, and first and second catalyst electrodes provided to face each other with the electrolyte membrane in between; and first and second separators provided facing each other with the membrane-electrode assembly in between, wherein the first catalyst electrode may include a first catalyst layer located on an electrolyte membrane side, and a first gas diffusion layer located on a first separator side, the second catalyst electrode may include a second catalyst layer located on an electrolyte membrane side, and a second gas diffusion layer located on the first separator side, and at least one of the first and second catalyst electrodes may include an anodic oxide film including a plurality of spaced apart through holes, and a catalyst layer containing a catalyst material may be included on inner walls of the through holes.

### Advantageous Effects

The present disclosure provides a membrane-electrode assembly for fuel cells, and a fuel cell including the same, wherein the cross-sectional area for reaction activation can be increased compared to the related art, and the reaction area can be made uniform for each product compared to the related art by making reaction gases (H2 and O2) undergo an ionization process while reacting with catalyst material, provided on the inner walls of regularly arranged through holes, while moving through channels formed by the through holes.

### DESCRIPTION OF DRAWINGS

FIG. 1 is an exploded perspective view of a fuel cell according to a preferred embodiment of the present disclosure;

FIG. 2 is a cross-sectional view of the fuel cell according to the preferred embodiment of the present disclosure;

FIG. 3 is a cross-sectional view of a membrane-electrode assembly according to a preferred embodiment of the present disclosure;

FIG. 4 is a cross-sectional view of the membrane-electrode assembly according to the preferred embodiment of the present disclosure;

FIG. 5 is a perspective view of an anodic oxide film constituting the membrane-electrode assembly according to the preferred embodiment of the present disclosure;

FIG. 6 is an enlarged perspective view of a catalyst material provided in the anode oxide film according to the preferred embodiment of the present disclosure;

FIG. 7 is a perspective view showing via holes provided in the anodic oxide film constituting the membrane-electrode assembly according to the preferred embodiment of the present disclosure;

FIG. 8 is a perspective view showing the via holes provided in the anodic oxide film constituting the membrane-electrode assembly according to the preferred embodiment of the present disclosure;

FIG. 9 is a cross-sectional view showing the catalyst material provided in the anode oxide film constituting the membrane-electrode assembly according to the preferred embodiment of the present disclosure; and

FIGS. 10(a) to 10(c) are cross-sectional views showing the catalyst material provided in the anode oxide film constituting the membrane-electrode assembly according to the preferred embodiment of the present disclosure.

### MODE FOR INVENTION

The following merely exemplifies the principles of the disclosure. Therefore, those skilled in the art will be able to devise various devices which, although not explicitly described or shown herein, embody the principles of the disclosure and are included within the spirit and scope of the disclosure. In addition, it should be understood that all conditional terms and examples listed herein are, in principle, expressly intended only for the purpose of understanding the inventive concept and are not limited to the specifically enumerated embodiments and states as such.

The above objects, features and advantages will become more apparent through the following detailed description in conjunction with the accompanying drawings, and accordingly, those skilled in the art to which the disclosure pertains will be able to easily practice the technical idea of the disclosure. Embodiments described herein will be described with reference to cross-sectional and/or perspective views, which are ideal illustrative drawings of the present disclosure. The thicknesses of films and regions shown in these drawings are exaggerated for effective explanation of technical content. The form of the illustrative drawings may be changed depending on manufacturing technology and/or tolerances. Accordingly, embodiments of the present disclosure are not limited to the specific form shown, but also include changes in the form generated according to the manufacturing process. Technical terms used herein are merely used to describe specific embodiments and are not intended to limit the present disclosure. The singular expression includes the plural expression unless the context clearly dictates otherwise. It will be further understood that the terms “comprise”, “comprising”, “include”, and/or “including”, when used herein, specify the presence of stated features, numbers, steps, operations, elements, and/or components but do not preclude the presence or addition of one or more other features, numbers, steps, operations, elements, components, and/or groups thereof.

Hereinafter, preferred embodiments of the present disclosure will be described in detail with reference to the attached drawings.

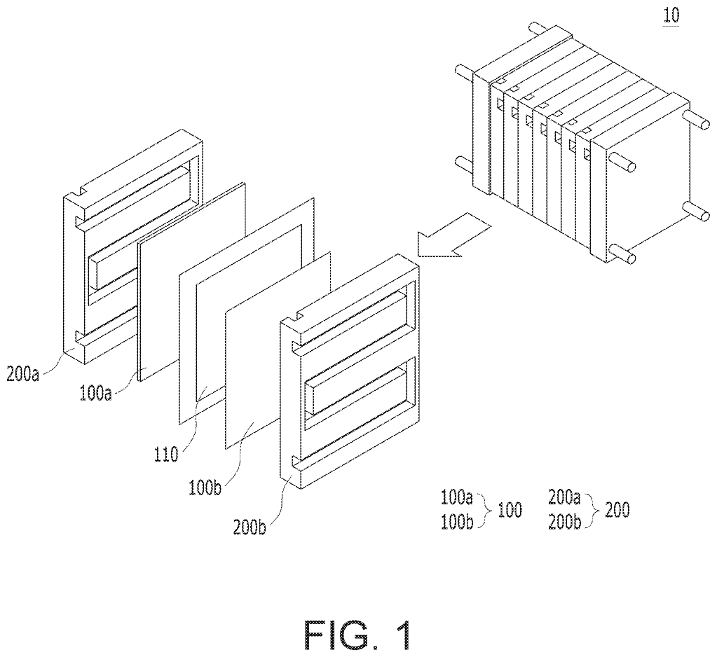

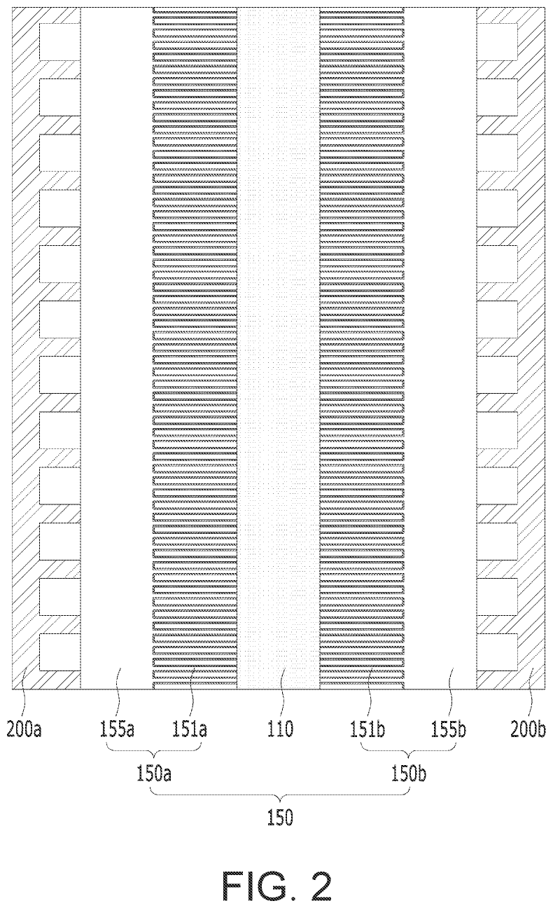

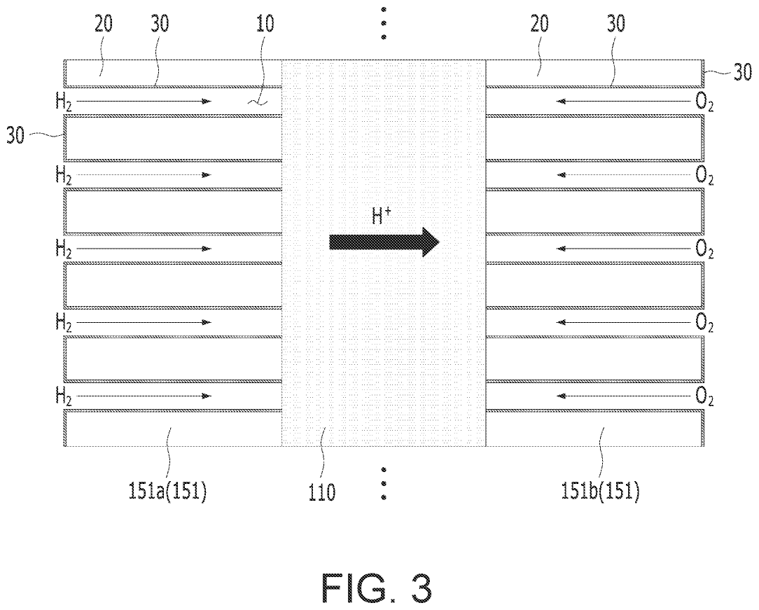

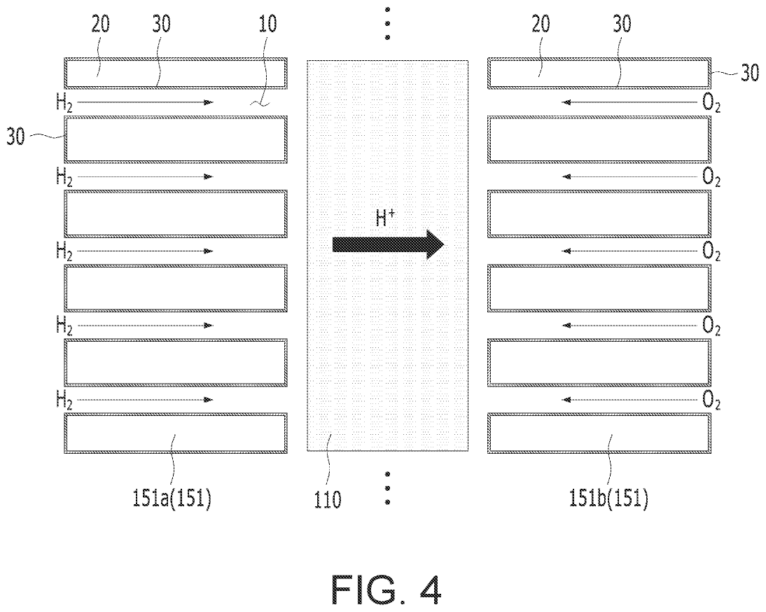

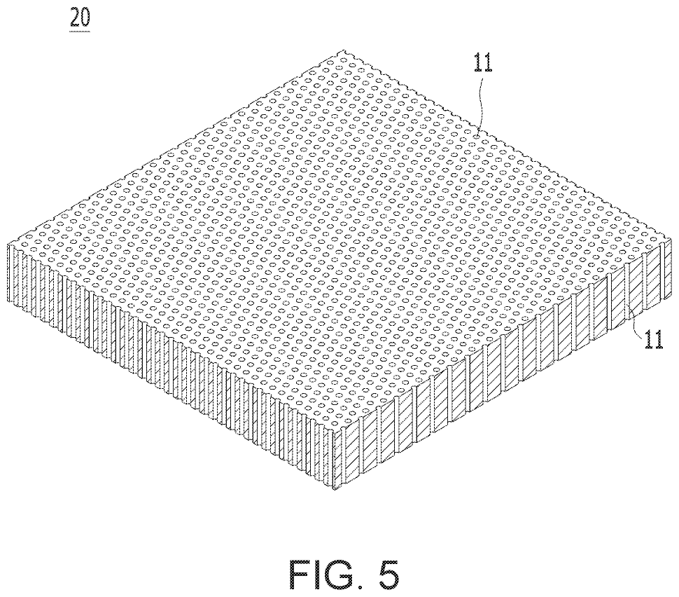

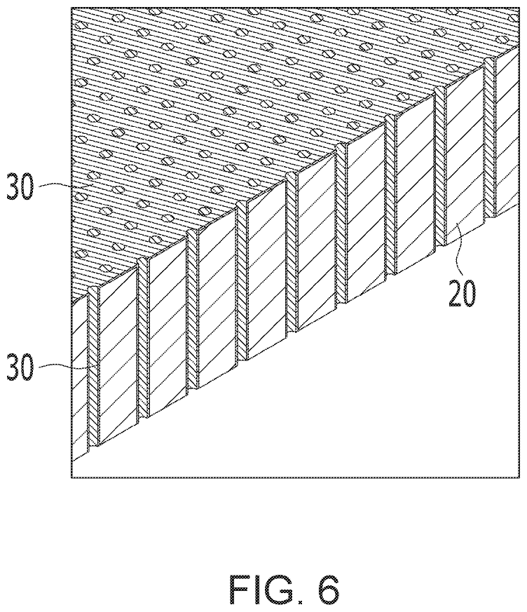

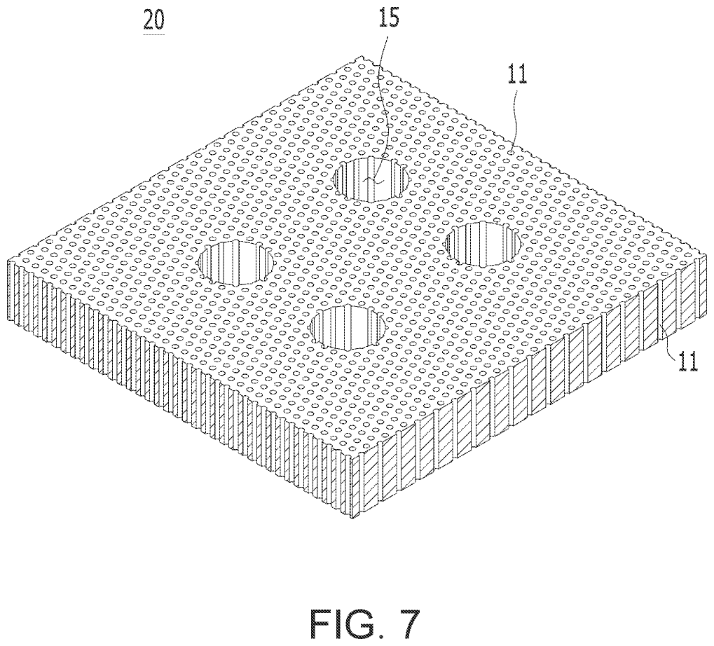

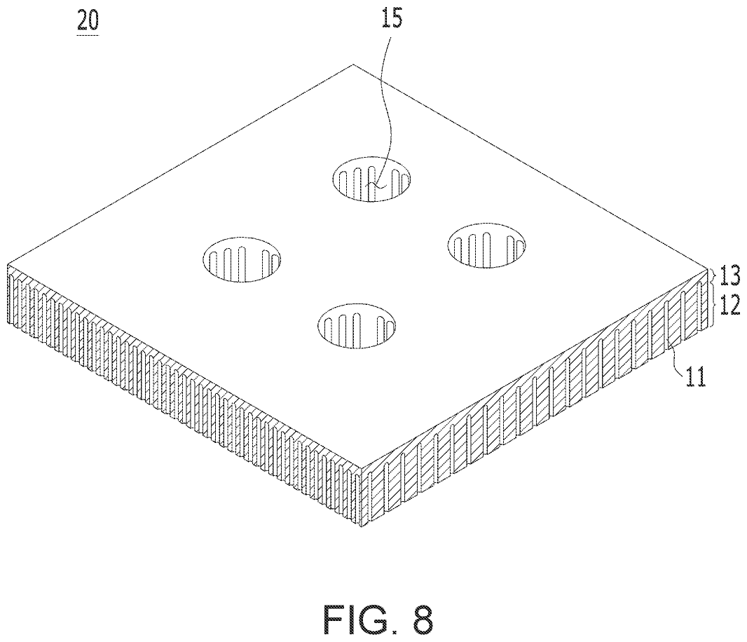

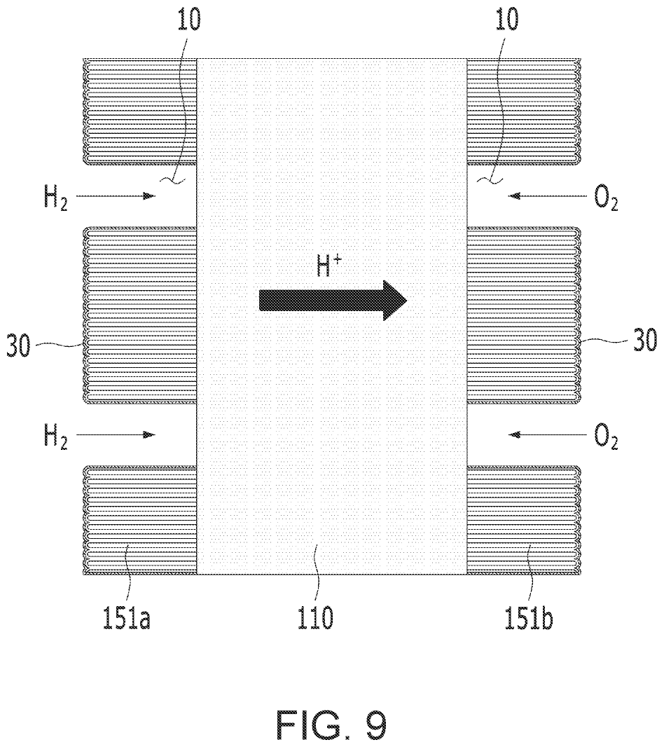

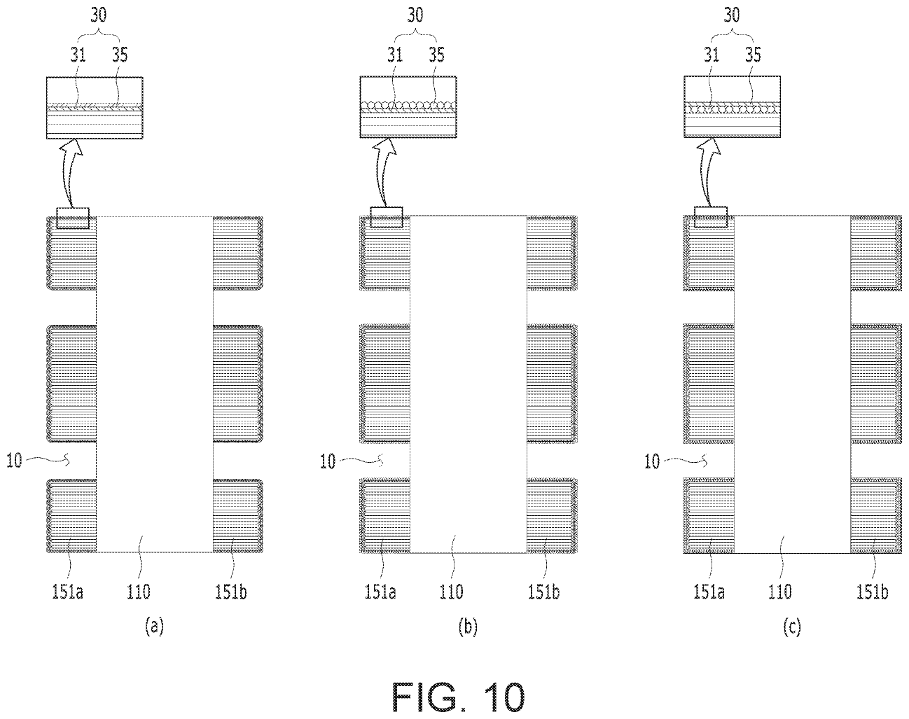

FIG. 1 is an exploded perspective view of a fuel cell according to a preferred embodiment of the present disclosure; FIG. 2 is a cross-sectional view of the fuel cell according to the preferred embodiment of the present disclosure; FIG. 3 is a cross-sectional view of a membrane-electrode assembly according to a preferred embodiment of the present disclosure; FIG. 4 is a cross-sectional view of the membrane-electrode assembly according to the preferred embodiment of the present disclosure; FIG. 5 is a perspective view of an anodic oxide film constituting the membrane-electrode assembly according to the preferred embodiment of the present disclosure; FIG. 6 is an enlarged perspective view of a catalyst material provided in the anode oxide film according to the preferred embodiment of the present disclosure; FIG. 7 is a perspective view showing via holes provided in the anodic oxide film constituting the membrane-electrode assembly according to the preferred embodiment of the present disclosure; FIG. 8 is a perspective view showing the via holes provided in the anodic oxide film constituting the membrane-electrode assembly according to the preferred embodiment of the present disclosure; FIG. 9 is a cross-sectional view showing the catalyst material provided in the anode oxide film constituting the membrane-electrode assembly according to the preferred embodiment of the present disclosure; and FIGS. 10(a) to 10(c) are cross-sectional views showing the catalyst material provided in the anode oxide film constituting the membrane-electrode assembly according to the preferred embodiment of the present disclosure.

The fuel cell includes at least one fuel cell 10 according to a preferred embodiment of the present disclosure. Referring to FIGS. 1 and 2, the fuel cell 10 includes a membrane-electrode assembly 100 and a pair of separators 200 sandwiching the membrane-electrode assembly 100. The membrane-electrode assembly 100 includes an electrolyte membrane 200 and a pair of catalyst electrodes 150 sandwiching the electrolyte membrane 200. That is, the fuel cell 10 includes the membrane-electrode assembly 100 including the electrolyte membrane 110 and first and second catalyst electrodes 150a and 150b provided to face each other with the electrolyte membrane 200 interposed therebetween, and first and second separators 200a and 200b provided to face each other with the membrane-electrode assembly 100 interposed therebetween.

A catalyst layer 151 is a layer containing a catalyst for the redox reaction of hydrogen or oxygen. A gas diffusion layer 155 is a porous layer with conductivity. The material of the gas diffusion layer 155 is not particularly limited as long as the material is conductive and can diffuse the reactive gas. The gas diffusion layer 155 may include: a gas diffusion base layer (not shown) that diffuses a first gas supplied from the separator 200 side into the catalyst layer 151; and a carbon coating layer (not shown) that improves the contact between the gas diffusion base layer (not shown) and the catalyst layer 151.

The first catalyst electrode 150a includes a first catalyst layer 151 located on the electrolyte membrane 110 side and a first gas diffusion layer 155a located on the first separator side while the second catalyst electrode 150b includes a second catalyst layer located on the electrolyte membrane side and a second gas diffusion layer 115b located on the second separator 200b side.

The electrolyte membrane 110 may be a polymer membrane having hydrogen ion conductivity. The material of the polymer electrolyte membrane is not particularly limited as long as the material selectively moves hydrogen ions.

The separator 200 is a conductive plate made of carbon or metal, and includes the first separator 200a in which a first gas flow path is formed on the surface thereof opposite to the first catalyst electrode 150a; and the second separator 200b in which a second gas flow path is formed on the surface thereof opposite to the second catalyst electrode 150b.

The first gas supplied to a first gas supply manifold of the fuel cell 10 is supplied to the first gas flow path inside the first separator 200a. The first gas in the first gas flow path diffuses and moves to the first catalyst layer 151 through the first gas diffusion layer 155a. On the other hand, a second gas supplied to a second gas supply manifold of the fuel cell 10 is supplied to the second gas flow path inside the second separator 200b. The second gas in the second gas flow path diffuses and moves to the second catalyst layer 151b through the second gas diffusion layer 115b. In the first catalyst layer 151b, hydrogen molecules contained in the first gas moving from the first gas flow path are divided into hydrogen ions and electrons. The hydrogen ions diffuse and move through the polymer electrolyte membrane 110 to the second catalyst layer 151b. Meanwhile, the electrons move to the second catalyst layer 151b through an external circuit not shown. In the second catalyst layer 151b, hydrogen ions moving through the polymer electrolyte membrane 100, electrons moving through the external circuit, and oxygen moving from the second gas flow react to produce water. Since the temperature of the fuel cell 10 during power generation is high, the produced water becomes water vapor and diffuses and moves into the second gas flow path through the second gas diffusion layer 115b.

At least one catalyst layer 151 among the catalyst layers 151 according to a preferred embodiment of the present disclosure includes an anodic oxide film 20 including a plurality of spaced apart through holes 10, and a catalyst material 30 is provided on the inner wall of the through holes 10.

In the conventional case, it is difficult to make the reaction area uniform and there are limitations in increasing the reaction area as reaction gases (H2, O2) undergo an ionization process while move through channels formed by random pores. However, in the case of the membrane-electrode assembly 100 according to a preferred embodiment of the present disclosure, the reaction gases (H2, O2) undergo an ionization process while reacting with catalyst material, provided on the inner walls of regularly arranged pores, while moving through channels formed by the pores, so that the cross-sectional area for reaction activation may be increased compared to the conventional case, and the reaction area may be made uniform for each product compared to the conventional case. In addition, conventionally, since platinum (Pt) fine particles are supported on the surface of carbon black, it is difficult to uniformly control the porosity for random pores. In contrast, according to a preferred embodiment of the present disclosure, since the through holes 10 formed in the catalyst layer 151 may be precisely controlled as intended, the porosity of each product may be uniformly controlled.

Additionally, the anodic oxide film 20 has a thermal expansion coefficient of 2 to 3 ppm/° C. Since the fuel cell 10 during power generation is at a high temperature, even if the temperature change is large, the anode oxide film 20 has little thermal deformation due to the temperature change. In the conventional case, because the material constituting the catalyst layer has poor temperature stability, the porosity of random pores changes depending on temperature. In contrast, the catalyst layer 151 according to a preferred embodiment of the present disclosure has the anodic oxide film 20 as its basic structure, and thus temperature stability may be improved and changes in porosity due to temperature changes may be minimized.

Referring to FIGS. 2 and 3, both the first catalyst layer 151a and the second catalyst layer 151b are composed of an anodic oxide film 20. The catalyst material 30 covers the entire exposed surface of the anodic oxide film 20, including the inner walls of the through holes 10 and the upper and lower surfaces of the anodic oxide film 20. In other words, all surfaces of the anodic oxide film 20 in contact with the reaction gas are covered by the catalyst material 30. Due to the configuration in which the catalyst material 30 is formed not only on the inner walls of the through holes 10 but also on the upper and lower surfaces of the anodic oxide film 20, the cross-sectional area for reaction activation may be further increased.

The catalyst material 30 is selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy. The catalyst material 30 is formed to a uniform thickness along the inner walls of the through holes 10 and the upper and lower surfaces of the anodic oxide film 20. The catalyst material 30 may be formed to a uniform thickness within the range of 1 nm to 100 nm by atomic layer deposition (ALD). The catalyst material 30 may preferably be formed by depositing ruthenium (Ru) using atomic layer deposition (ALD). Meanwhile, the catalyst material 30 may be formed of a platinum-ruthenium alloy, which is a multi-element alloy. Due to this, the affinity of ruthenium (Ru) for the hydroxyl group effectively removes carbon monoxide, which strongly binds to platinum (Pt) particles, by oxidizing the carbon monoxide to carbon dioxide, thereby improving the durability of the fuel cell 10. Meanwhile, a conductive layer (not shown) may be additionally provided between the surface of the catalyst material 30 and the anodic oxide film 20.

Referring to FIG. 4, unlike the configuration shown in FIG. 3, the first catalyst layer 151a and the electrolyte membrane 110 are provided to be spaced apart by a predetermined distance, and the second catalyst layer 151b and the electrolyte membrane 110 are also provided to be spaced apart by a predetermined distance. The separation distance between the first catalyst layer 151a and the electrolyte membrane 110 may be between 1 nm and 100 nm, and the distance between the second catalyst layer 151) and the electrolyte membrane 110 may be between 1 nm and 100 nm. Due to this, the first gas passing through the through holes 10 of the first catalyst layer 151a may react with the catalyst material 30 over a wider area, and the second gas passing through the through holes 10 of the second catalyst layer 151b may react with the catalyst material 30 over a wider area, thereby further promoting reaction activation.

Referring to FIG. 5, the anodic oxide film 20 is manufactured by anodizing a base metal (parent metal) and then removing the base metal. The anodic oxide film 20 refers to a film formed by anodizing the base metal, and a pore hole 11 refers to a hole formed in the process of forming an anodic oxide film by anodizing the base metal. As an example, assuming that the base metal is aluminum (Al) or an aluminum alloy, when the base metal is anodized, an anodic oxide film 20 made of anodized aluminum oxide (Al2O3) is formed on the surface of the base metal. The anodic oxide film 20 may be composed of: a porous layer 12 with the pore hole 11 formed therein; and a barrier layer 13 that closes the pore hole 11 at one end of the pore hole 11. The barrier layer 13 is formed on top of the base metal during anodization, and the porous layer 12 is formed on one side of the barrier layer 13. To be specific, when anodizing the base metal, the barrier layer 13 is first formed on the base metal, and when the barrier layer 13 reaches a predetermined thickness, the porous layer 12 is formed on the barrier layer 13. The thickness of the barrier layer 13 may vary depending on the anodization process conditions, but is preferably formed between several tens of nm and up to several μm, and more preferably between 100 nm and 1 μm. The thickness of the porous layer 12 may also vary depending on the anodization process conditions, but is preferably formed to be from tens of nm to hundreds of μm. The diameter of the pore hole 11 forming the porous layer 12 may be from several nm or more to hundreds of nm or less. After the anodization process is completed, the process of removing the base metal may be performed. Through this process, an anodic oxide film 20 made of anodized aluminum oxide (Al2O3) remains. The catalyst layer 151 uses this anodic oxide film 20.

The anodic oxide film 20 may be configured with the barrier layer 13 that seals one end of the pore hole 11 (see FIG. 8), or may be configured so that the barrier layer 13 formed during anodization is removed and both ends of the pore hole 11 are exposed.

The through hole 10 according to a preferred embodiment of the present disclosure may be the pore hole 11 described above. In this case, the anodic oxide film 20 is configured so that the barrier layer 13 is removed and the pore hole 11 is penetrated so that the reaction gases (H2, O2) may pass through.

Referring to FIG. 6, the catalyst material 30 is formed to a uniform thickness along the inner walls of the pores 11 and the upper and lower surfaces of the anodic oxide film 20. The catalyst material 30 may be formed to a uniform thickness within a range of 1 nm to 100 nm by atomic layer deposition (ALD). Since the pores 11 are formed into millions to tens of millions of holes spaced at regular intervals during the manufacture of the anodic oxide film 20, the cross-sectional area for reaction activation may be increased and the reaction area may be made uniform, maintaining the quality of the membrane-electrode assembly 100 consistent.

Meanwhile, the through hole 10 according to the preferred embodiment of the present disclosure may be a via hole 15 provided separately from the pore hole 11. Referring to FIG. 7, the anodic oxide film 20 has the via hole 15. In other words, the through hole 10 is the via hole 15 formed to have a diameter larger than the diameter of the pore hole 11 formed when manufacturing the anodic oxide film 20 by anodizing the base metal. The anodic oxide film 20 has the via hole 115 that has a width larger than the width of the pore hole 11, separately from the pore hole 11. The via hole 15 may have an inner diameter ranging from several μm to hundreds of μm or less. The via hole 15 may be provided by an etching process. Millions to tens of millions of via holes 15 may be formed at once in a single etching process using an etching solution (for example, an alkaline solution) that reacts wetly with the anodic oxide film 20. The via hole 15 may be formed by forming a photoresist on one side of the anodic oxide film 20, patterning the photoresist to form an opening area, and then making an etching solution flow through the opening area. Thus, the shape of the patterned opening area is copied to produce the cross-sectional shape of the via hole 15.

Because the via hole 15 is formed by an etching process using the patterned photoresist as a mask, there are no limitations on the cross-sectional shape of the via hole 15, and the inner wall of the via hole 15, which is formed by the reaction of the anodic oxide film 20 with the etching solution, forms a vertical inner wall. The catalyst material 30 may be formed along the inner walls of the via holes 15 and the upper and lower surfaces of the anodic oxide film 20.

Referring to FIGS. 8 and 9, unlike the configuration shown in FIG. 7, the via hole 15 may be provided in a structure with a barrier layer 13.

The anodic oxide film 20 includes: the porous layer 12 having the pores 11; and the barrier layer 13 formed on one side of the porous layer 12 to seal the pore hole 11. In the configuration of the anodic oxide film 20 provided with the barrier layer 13, since a photoresist is formed on the upper surface of the barrier layer 13 when forming the via hole 15, foreign substances are prevented from remaining in the pore hole 11 when the photoresist is removed, thereby further improving the quality of the membrane-electrode assembly 100.

Meanwhile, the barrier layer 13 may be provided to face the opposite side of the electrolyte membrane 110. In other words, the barrier layer 13 of the first catalyst layer 151a is located on the side opposite to the first gas diffusion layer 155a, while the barrier layer 13 of the second catalyst layer 151b is located on the side opposite to the second gas diffusion layer 155b. Due to this configuration, the reaction activity efficiency may be further improved by preventing eddy currents in the reaction gases (H2, O2) flowing toward the electrolyte membrane 110.

Referring to FIGS. 10(a) to 10(c), the catalyst material 30 may be composed of a plurality of layers including a first layer 31 and a second layer 35.

Referring to FIG. 10(a), the catalyst material 30 includes the first layer 31 selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy. The first layer 31 is formed with a uniform thickness along the inner walls of the through holes and the upper and lower surfaces of the anodic oxide film. In addition, the catalyst material 30 includes the second layer 35 selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but made of a different material from the first layer 31 and formed on the first layer 31. The second layer 35 is formed with a uniform thickness along the surface of the first layer 31.

Preferably, the first layer 31 is composed of platinum (Pt) and the second layer 35 is composed of ruthenium (Ru), and the first layer 31 and the second layer 35 have different thicknesses. The first layer 31 may be formed by sputtering and the second layer 35 may be formed by atomic layer deposition (ALD). At this time, ruthenium (Ru) is a protective layer of the first layer 31 and may perform the function of preventing the first layer 31 from being deteriorated.

Referring to FIG. 10(b), the catalyst material 30 includes the first layer 31 selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, and the first layer 31 is formed to have a uniform thickness. In addition, the catalyst material 30 includes the second layer 35 selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but made of a different material from the first layer 31 and formed on the first layer 31. The second layer 35 is provided in powder form.

The first layer 31 may be formed by atomic layer deposition (ALD) or sputtering.

After forming the first layer 31, the second layer 35 is selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but is formed by being supported on powder having a diameter of 1 nm or more and 100 nm or less.

Referring to FIG. 10(c), the catalyst material 30 includes the first layer 31 selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, and the first layer 31 is provided in powder form. In addition, the catalyst material 30 includes the second layer 35 selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but made of a different material from the first layer 31 and formed on the first layer 31. The second layer 35 is formed to have a uniform thickness.

The first layer 31 is selected from the group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but is formed by being supported on powder having a diameter of 1 nm or more and 100 nm or less. After forming the first layer 31, the second layer 35 is formed by atomic layer deposition (ALD). Since the second layer 35 is formed by atomic layer deposition, the surface area of the first layer 31 may be maintained, unwanted pores through which the reaction gas cannot penetrate are removed, and deterioration of the first layer 31 is prevented.

As described above, although the present disclosure has been described with reference to preferred embodiments, a person skilled in the art may implement the present disclosure by changing or modifying the present disclosure in various ways without departing from the spirit and scope of the present disclosure as set forth in the claims below.

### DESCRIPTIONS OF NUMERALS

10: fuel cell
100: membrane-electrode assembly
110: electrolyte membrane
150: catalyst electrode
151: catalyst layer
155: gas diffusion layer
200: separator

1. A membrane-electrode assembly for fuel cells, the membrane-electrode assembly comprising:
an electrolyte membrane; and
a pair of catalyst electrodes provided to face each other with the electrolyte membrane in between,
wherein at least one of the catalyst electrodes comprises an anodic oxide film including a plurality of spaced apart through holes, and a catalyst layer containing a catalyst material is included on inner walls of the through holes.

2. The membrane-electrode assembly of claim 1, wherein the catalyst material covers an entire exposed surface of the anodic oxide film, including the inner walls of the through holes and upper and lower surfaces of the anodic oxide film.

3. The membrane-electrode assembly of claim 1, wherein the catalyst material is formed to a uniform thickness within a range of 1 nm to 100 nm.

4. The membrane-electrode assembly of claim 1, wherein each of the through holes is a pore hole formed when manufacturing the anodic oxide film by anodizing a base metal.

5. The membrane-electrode assembly of claim 1, wherein each of the through holes is a via hole formed to have a diameter larger than a diameter of a pore hole formed when manufacturing the anodic oxide film by anodizing a base metal.

6. The membrane-electrode assembly of claim 1, wherein the anodic oxide film comprises:
a porous layer having a pore hole; and
a barrier layer formed on a side of the porous layer to seal the pore hole,
wherein the barrier layer is provided to face an opposite side of the electrolyte membrane.

7. The membrane-electrode assembly of claim 1, wherein the catalyst material comprises a first layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy,
wherein the first layer is formed with a uniform thickness along the inner walls of the through holes and upper and lower surfaces of the anodic oxide film.

8. The membrane-electrode assembly of claim 7, wherein the catalyst material comprises a second layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but selected from a material different from the first layer and provided on the first layer,
wherein the second layer is formed with a uniform thickness along a surface of the first layer.

9. The membrane-electrode assembly of claim 1, wherein the catalyst material comprises:
a first layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy; and
a second layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but selected from a material different from the first layer and provided on the first layer,
wherein the first layer is provided in powder form, and the second layer is formed to have a uniform thickness.

10. The membrane-electrode assembly of claim 1, wherein the catalyst material comprises:
a first layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy; and
a second layer selected from a group consisting of platinum, ruthenium, osmium, platinum-ruthenium alloy, platinum-osmium alloy, platinum-palladium alloy, platinum-chromium alloy, platinum-nickel alloy, platinum-iron alloy, platinum-cobalt alloy, platinum-titanium alloy, and platinum-magnesium alloy, but selected from a material different from the first layer and provided on the first layer,
wherein the first layer is formed to have a uniform thickness, and the second layer is provided in powder form.

11. A fuel cell comprising:
a membrane-electrode assembly including an electrolyte membrane, and first and second catalyst electrodes provided to face each other with the electrolyte membrane in between; and
first and second separators provided facing each other with the membrane-electrode assembly in between,
wherein the first catalyst electrode comprises a first catalyst layer located on an electrolyte membrane side, and a first gas diffusion layer located on a first separator side,
the second catalyst electrode comprises a second catalyst layer located on an electrolyte membrane side, and a second gas diffusion layer located on the first separator side, and
at least one of the first and second catalyst electrodes comprises an anodic oxide film including a plurality of spaced apart through holes, and a catalyst layer containing a catalyst material is included on inner walls of the through holes.
